(19) United States
(12) Patent Application Publication
(10) Pub. No.: US 2026/0257760 A1
(43) Pub. Date: Sep. 3, 2026

(54) Drive unit for an electric bicycle with an inserted bearing element for a transmission assembly and installation method

(71) Applicant: Brose Antriebstechnik GmbH & Co. Kommanditgesellschaft, Berlin, Berlin (DE)

(72) Inventors: Christoph EHEHALT-BOHM, Kurnach (DE); Michael JACOB, Meura (DE); Daniel HUCKSTADT, Berlin (DE); Robert FRIEDLAND, Strausberg (DE); Stefanie PFRIEM, Gerbrunn (DE)

(21) Appl. No.: 19/165,038

(22) PCT Filed: Mar. 11, 2024
(86) PCT No.: PCT/EP2024/056433

§ 371 Date: Sep. 12, 2025

(30) Foreign Application Priority Data
Mar. 14, 2023 (DE) 10 2023 106 363.4

(51) Int. Cl. B62M 11/06; B62M 6/55

(52) U.S. Cl. CPC B62M 11/06; B62M 6/55

(57) ABSTRACT

The proposed solution relates in particular to a drive unit for an electric bicycle, comprising—at least one electromotive drive, —a bottom bracket spindle assembly and—a transmission assembly for transferring a drive torque generated by the electromotive drive to an output element of the bottom bracket spindle assembly, wherein the transmission assembly has a transmission carrier on which at least two interacting transmission elements are each mounted so as to be rotatable. One of the transmission elements is mounted on the transmission carrier via a bearing element so as to be rotatable about a rotational axis, a first end portion of said bearing element being inserted in a rotationally fixed manner in a portion of the transmission carrier, a second end portion defining an axial position, in relation to the rotational axis, of the one transmission element on the transmission carrier and having a centre portion, provided between the first and the second end portions, for rotatably mounting the one transmission element.

### CROSS-REFERENCE TO RELATED APPLICATION

This application is a National Stage of International Application No. PCT/EP2024/056433 filed on Mar. 11, 2024, which claims priority from German Patent Application 10 2023 106 363.4, filed on Mar. 14, 2023. The contents of the above document are incorporated herein by reference in its entirety.

### BACKGROUND OF THE INVENTION

### Field of the Invention

The proposed solution relates in particular to a drive unit for an electric bicycle.

### Description of the Related Art

Drive units for electric bicycles with at least one electric motor drive are widely known. At least one electric motor drive is used here to provide a drive torque generated by external force operation at an output element of the drive unit. The output element is then coupled, for example, to a force transmission element which is connected to a rear wheel of the electric bicycle via a transmission member, such as a belt or a chain. The drive torque generated by external force operation is typically provided in addition to a drive torque generated by muscle force operation that is introduced at a pedal shaft via pedals.

The output element and the force transmission element are regularly provided on a pedal shaft assembly comprising the pedal shaft with a freewheel. This supports a compact configuration of the drive unit, since the rotation axis of the pedal shaft is identical to the rotation axes of the output element and the force transmission element.

In drive units for electric bicycles, there is still a need to reduce weight, increase power density, and/or facilitate the installation of the drive unit.

### SUMMARY OF THE INVENTION

Against this background, a drive unit is proposed in which a transmission assembly with a transmission carrier, on which at least two interacting transmission elements are each rotatably supported, is provided for transmitting a drive torque generated by the electric motor drive to an output element of the pedal shaft assembly. One of these transmission elements is rotatably supported on the transmission carrier about a rotational axis via a bearing element, wherein the bearing element a) is plugged with a first end portion into a portion of the transmission carrier in a rotationally fixed manner, b) specifies an axial position of the one transmission element on the transmission carrier relative to the rotation axis with a second end portion, and c) has a central portion provided between the first and second end portions for the rotatable support of the one transmission element.

In a proposed drive unit, a transmission assembly with a bearing element is therefore provided, via which both radial and axial positioning is carried out for at least one of the transmission elements. A corresponding functional integration not only facilitates the assembly of the transmission assembly and thus the assembly of the drive unit. Rather, it can also be achieved, that individual assemblies of the drive unit can be pre-assembled and then combined to form the drive unit more easily.

The bearing element provided in the transmission assembly of the proposed drive unit ensures the fixing of the bearing element to the transmission carrier with its first end portion. The central portion provided between the first and second end portions of the bearing element defines the rotation axis for the transmission element, which in turn is fixed in its axial position via the second end portion. The axial position of the rotatable transmission element on the transmission carrier is therefore fixed via the second end portion. The one bearing element thus ensures accurate positioning of the transmission element on the transmission carrier and thus in relation to the other transmission element on the transmission carrier with which it interacts, in a preferred embodiment in particular without the need to assemble additional components to the transmission carrier after attachment of the bearing element to the transmission carrier.

For example, the first end portion of the bearing element is pressed into an opening in the portion on the transmission carrier side. The fixation of the bearing element, which provides the rotation axis for the transmission element, is thus ensured by a force-fit connection between the portion on the transmission carrier side and the first end portion of the bearing element. A first end portion provided to be pressed into an opening of the transmission carrier can further simplify assembly.

For example, a shoulder is formed at the second end portion, via which the axial position of the rotatably supported transmission element is specified. A shoulder is thus formed at the second end portion of the bearing element, and thus a shoulder, which, when the bearing element is assembled, is brought into contact in the axial direction with the transmission element to be rotatably supported or a component connected to it in a rotatably fixed manner, so that the axial position of the transmission element on the transmission carrier is specified by this. For example, the transmission element can be rotatably supported on the central portion of the bearing element via a bearing, the inner ring of which is connected to the central portion in a rotatably fixed manner. In this way, for example, the shoulder of the second end portion can abut axially against the inner ring of the bearing, which is designed, for example, as a roller bearing.

In order to ensure in this context that the inner ring of the bearing is fixed and clamped in the axial direction via the shoulder of the second end portion when the bearing element is inserted, an axial length of the central portion may be less than an axial length of the inner ring. Consequently, a width of the inner ring measured along the rotation axis is greater than the length of the central portion measured along the rotation axis. This allows a side of the inner ring spaced apart from the shoulder of the second end portion to be pressed against the portion on the transmission carrier side via the shoulder of the second end portion and thus fixed axially. The inner ring can thus be fixed between the shoulder of the second end portion and the portion on the transmission carrier side along the rotation axis by inserting the bearing element.

In one embodiment, the transmission element rotatably supported via the bearing element is formed by an annular gear wheel. This annular gear wheel can be connected in a rotationally fixed manner to a hub for weight optimization, which in turn is fixed to an outer ring of the bearing. The outer ring is rotatably supported relative to the inner ring, for example via several roller bodies. By providing a hub between the annular gear wheel and the outer ring of the bearing, which is formed by an additional component, the gear wheel does not have to be formed as a full-solid-body component made of a heavy and/or expensive material. For example, only the annular gear wheel can be made of high-strength steel, while the hub is made of a lighter aluminum material. The lighter hub can then be pressed into the annular gear wheel or into a gear ring formed with it, with a corresponding interference adjustment, and subsequently provide the connection to the outer ring of the bearing.

In one embodiment, the first end portion, the central portion, and the second end portion of the bearing element are formed on the bearing element with different diameters. A diameter of the second end portion is larger than the diameter of the central portion, and the diameter of the central portion is larger than the diameter of the first end portion. Such a (stepped) configuration of the bearing element allows, for example, the bearing element to be inserted into the transmission element to be rotatably supported along the rotation axis with the first end portion leading. In particular, it may be provided in this context that the bearing element is formed as a stepped bolt, in particular as a hollow stepped bolt, with outer diameters increasing stepwise from the first end portion, via the central portion, to the second end portion.

While the first end portion of the bearing element is plugged into the portion on the transmission carrier side and thus fixed thereto and at least radially supported, in one embodiment the second end portion may be radially supported by a bearing shield. Such a bearing shield is fixed to the transmission assembly and is connected to the second end portion in a form-fitting manner. For example, a bearing opening is provided on the bearing shield for this purpose, in which the second end portion is received in a form-fitting manner. If necessary, the second end portion protrudes through the corresponding opening on the bearing shield.

If a part of the second end portion protrudes through the bearing opening on the bearing shield, the part of the second end portion protruding through the bearing opening can, in a possible further development, be received in a receptacle provided in a (housing) part of a housing of the drive unit, which receives the electric motor drive and the transmission assembly provided with the bearing shield. Such a receptacle can then be formed, for example, on the corresponding (housing) part of the housing, namely on an inner side facing a housing space of the housing in which the electric motor drive and the transmission assembly with the bearing shield are accommodated. When assembling the drive unit, the electric motor drive and the transmission assembly as well as the bearing shield are first assembled to a first housing part. Later, the housing space is closed by a second housing part, on which the receptacle accommodating the protruding part of the second end portion is provided. In this way, a (if necessary, additional) radial support for the bearing element at the second end portion can be provided by the second housing part and thus the housing of the drive unit. This allows a sufficient support of the bearing element providing the rotation axis for the transmission element to be further enhanced without leading to increased complexity of the drive unit assembly.

In principle, the at least two transmission elements rotatably supported on the transmission carrier and interacting with each other can be different types of transmission elements, for example friction wheels or belt wheels. In one embodiment, the transmission elements interacting with each other are gear wheels. For example, a stepped gear wheel (a first transmission stage) can be rotatably supported on the transmission carrier, which meshes with a pinion of a rotor shaft of a rotor assembly of the electric motor drive. This stepped gear wheel is then coupled to a stepped pinion as the first transmission element (a second transmission stage) of the transmission assembly in a rotationally fixed manner. As a second transmission element, which is fixed to the transmission carrier via the bearing element, an intermediate gear wheel can be provided which meshes with the stepped pinion.

The intermediate gear wheel can in turn mesh with an output gear wheel of the pedal shaft assembly to transmit a motor generated drive torque to a force transmission element which, when the drive unit is attached to an electric bicycle, transmits a driving force to a rear wheel of the electric bicycle via a belt or chain.

In one variant, the stepped gear wheel and the stepped pinion of the transmission assembly are connected in a rotationally fixed manner to a bearing shaft, which is rotatably supported via a (first) bearing received on the transmission carrier. The bearing shaft can, for example, be formed with the stepped pinion and pressed into a shaft opening of the stepped gear wheel with one shaft end. Alternative configurations are of course also possible. For example, the stepped pinion can also be formed as a separate component and can be assembled to the bearing shaft.

In one embodiment, the stepped gear wheel of a two-stage gear wheel transmission provided on the transmission assembly has an externally toothed ring gear and a hub, wherein the ring gear is connected to the hub of the stepped gear wheel via a carrier structure having a plurality of through openings. The stepped gear wheel can therefore be formed as a single-piece full-solid body with the hub and the ring gear. However, in order to optimize stiffness, weight, and/or operating noise, in such an embodiment, it is provided that several through openings are formed in the carrier structure connecting the hub to the ring gear. A plurality of through openings in the carrier structure can serve not only to reduce weight, but also to reduce airborne sound, which leads to disturbing operating noise for a user of the drive unit during operation of the drive unit under circumstances, especially if the airborne sound also excites the housing of the drive unit. In addition, a carrier structure having several through openings obviously goes along with a significant reduction in the weight of the stepped gear wheel.

In a possible further development, the through openings are dimensioned in such a way that the carrier structure is ultimately formed only by several carrier portions extending from the hub to the ring gear in a spoke-like manner (e.g., in the manner of radial struts).

Alternatively, the several through openings may be arranged sequentially in the carrier structure in a row extending along a circumferential direction around the rotation axis of the stepped gear wheel. For example, the through openings thus follow one another along a circular line around the rotation axis of the stepped gear wheel. If necessary, the through openings are further arranged equidistantly.

In the course of a further stiffness—and/or airborne sound-optimized design, it may be provided that the through openings are not circular, but are formed with at least partially curved or arrow-shaped contours. This means that a rotation direction is specified for the stepped gear wheel during operation of the drive unit in order to transmit a drive torque generated by the electric motor drive in the direction of the output element of the pedal shaft assembly. The through openings can now each have a contour in which the opening edges opposite to each other in the circumferential direction and extending from the hub in the direction of the ring gear (centrally) extend in a direction opposite to the rotation direction and are thus, for example, curved or divided in the direction opposite to the rotation direction.

For further functional integration on the transmission carrier of the transmission assembly, it may be provided in one embodiment, that the transmission carrier comprises a bearing portion on which at least part of an electronic assembly of the drive unit is fixed. The transmission carrier can thus, for example, form a bearing portion for fixing the electronic assembly in the housing of the drive unit away from those areas where the rotatable transmission elements are supported on the transmission carrier. A corresponding bearing portion can, for example, serve to fix at least a part of at least one circuit board of the electronic assembly of the drive unit. In the state of being assembled as intended, at least a part of a circuit board is therefore fixed to the bearing portion on the transmission carrier side. Such a circuit board may, for example, be parts of a control electronic for controlling the electric motor drive.

The proposed solution also relates to a method for assembling a drive unit for an electric bicycle. In a drive unit to be assembled according to the proposed assembly method, a transmission assembly with a transmission carrier is accommodated together with an electric motor drive in a housing of the drive unit, on which a pedal shaft assembly is also rotatably supported. In the proposed assembly method it is now provided that the transmission assembly is pre-assembled with at least two transmission elements already rotatably supported on the transmission carrier and interacting with each other as a structural unit and that this pre-assembled structural unit is assembled to a housing part of the housing that already comprises at least a stator of the electric motor drive.

In the course of this aspect of the proposed solution, it is therefore provided that the transmission assembly is pre-assembled and is thus testable separately for functionality before the transmission assembly is assembled to the housing part that already carries at least the stator of the electric motor drive by fixing the transmission carrier to the housing part.

It may be provided that the pre-assembled transmission assembly comprises a two-stage gear wheel transmission. In this case, for example, a stepped gear wheel, a stepped pinion coupled in a rotationally fixed manner to the stepped gear wheel as the first transmission element of the transmission assembly, and an intermediate gear wheel meshing with the stepped pinion as the second transmission element of the transmission unit are rotatably supported and pre-assembled on the transmission carrier of the transmission assembly. The stepped gear wheel is provided to mesh with a pinion of a rotor shaft of the electric motor drive.

The pre-assembly of the transmission assembly can generally be carried out using a bearing element in accordance with the first aspect explained above, thereby being additionally facilitated. The advantages and features explained above and below in connection with embodiments for a proposed drive unit can therefore also apply to embodiments of a proposed assembly method.

If a corresponding bearing element is provided, the bearing element can be assembled to the transmission element already arranged on the transmission carrier and be thereby guided with its first end portion through the transmission element and plugged into the portion on the transmission carrier side. If the transmission element to be supported rotatably on the transmission carrier via the bearing element is formed by the intermediate gear wheel mentioned above, an embodiment of the proposed assembly method provides that the bearing element is plugged onto the intermediate gear wheel already arranged on the transmission carrier (in a previous assembly step) and brought into meshing engagement with the stepped pinion.

Before the pre-assembled transmission assembly is assembled to the housing part, a rotor assembly with a rotor shaft may already have been assembled to the housing part that already comprises the stator. The rotor shaft of the rotor assembly then carries, for example, a pinion for meshing with the stepped gear wheel of the transmission assembly. On an end side to face the electric motor drive, the transmission carrier of the pre-assembled transmission assembly then has, for example, an opening for passing the pinion of the rotor shaft through, so that the pre-assembled transmission assembly can be assembled to the housing part already carrying the stator and the rotor with the pinion shaft, and the pinion of the rotor shaft can be brought into meshing engagement with the stepped gear wheel already rotatably supported on the transmission carrier.

In an alternative embodiment, it can be provided that a rotor assembly with a rotor shaft may be assembled to the transmission assembly beforehand, so that the transmission assembly pre-assembled with the rotor assembly can be assembled to the housing part already comprising the stator of the electric motor drive. A pinion of the rotor shaft is thus, for example, already brought into meshing engagement with the stepped gear wheel of the transmission assembly outside the housing part carrying the stator and already arranged on the transmission assembly as intended, so that the transmission assembly and the rotor assembly can be assembled as a pre-assembled assembly to the housing part in which the stator is already accommodated.

In general, a bearing shield can also be assembled to the transmission carrier. This bearing shield can be assembled to the transmission carrier before the transmission assembly is assembled to the housing part already comprising the stator of the electric motor drive, or afterwards. A corresponding bearing shield can, for example, enable a form-fitting receptacle of a second end portion of the bearing element mentioned above. Alternatively or additionally, the bearing shield can accommodate a (second) bearing, in particular a roller bearing, via which a bearing shaft of a stepped gear wheel assembly is rotatably supported, which comprises the stepped gear wheel meshing with the pinion of the rotor shaft and the stepped pinion of the transmission assembly connected in a rotationally fixed manner to the stepped gear wheel.

In one embodiment of the proposed assembly method, it can be provided for the insertion of an electronic assembly of the drive unit, that at least a part of such an electronic assembly, for example at least a part of a circuit board of the electronic assembly, is fixed to a bearing portion of the transmission carrier of the transmission assembly. This includes, for example, fixing a part of the electronic assembly to the bearing portion of the transmission carrier after the transmission assembly has been arranged as intended in a housing space of the housing of the drive unit that has not yet been closed.

Before a housing space of the housing, in which the electric motor drive and the transmission assembly are (completely) accommodated, is closed by a further (second) housing part of the housing, the pedal shaft assembly can still be assembled to the (first) housing part, which already carries at least the stator of the electric motor drive, during assembly. The two housing parts, which are fixed to each other in the state of being assembled as intended of the drive unit, then each have a pedal shaft opening for a pedal shaft of the pedal shaft assembly, so that a pedal can be attached to the respective end protruding from the housing (and the connection of a force transmission element of the pedal shaft assembly with a belt or chain is also possible on one side of the housing).

### BRIEF DESCRIPTION OF THE DRAWINGS

The accompanying figures exemplarily illustrate possible embodiments of the proposed solution.

FIG. 1A shows a first housing part of a housing of a proposed drive unit looking at the outside;

FIG. 1B shows the housing part of FIG. 1A rotated by 180° looking at an inside, where a stator of an electric motor drive is already inserted into a motor bearing location provided for this purpose;

FIG. 2 shows the first housing part of FIGS. 1A and 1B during assembly of the drive unit before insertion of a rotor assembly of the electric motor drive;

FIG. 3 shows the first housing part with the rotor assembly inserted as intended;

FIG. 4 shows the first housing part of FIG. 3 with a transmission assembly to be additionally fixed therein, which is to be coupled to a pinion of a rotor shaft of the electric motor drive, and a bearing shield at least partially covering transmission elements of the transmission assembly;

FIG. 5 shows the first housing part with the transmission assembly assembled as intended and the bearing shield fixed thereto;

FIG. 6 shows an intermediate gear wheel assembly of the transmission assembly of FIGS. 4 and 5, which is part of a second transmission stage of the two-stage transmission of the transmission assembly in an exploded view;

FIGS. 7A-7E show various phases of an assembly process for pre-assembling the transmission assembly;

FIG. 8A shows the transmission assembly already assembled to the first housing part before the bearing shield is assembled;

FIG. 8B shows the first housing part with the transmission assembly assembled to it and the bearing shield fixed to the transmission assembly;

FIG. 9 show a bearing element formed as a stepped bolt for the axial and radial positioning of the intermediate gear wheel assembly and thus of the intermediate gear wheel of the transmission assembly in a perspective individual view;

FIG. 10 shows a sectional view in the area of the intermediate gear wheel with the stepped bolt of FIG. 9 being assembled, which defines the rotation axis for the intermediate gear wheel;

FIG. 11 shows the first housing part after a further assembly step for assembling an electronic assembly, in which a circuit board is fixed to a bearing portion of the transmission carrier of the transmission assembly;

FIG. 12 shows the first housing part with the pedal shaft assembly still to be inserted thereto;

FIG. 13 shows a second housing part of the housing of the drive unit looking at an inside;

FIG. 14 shows the second housing part when being placed onto the first housing part to close a housing space that accommodates, in particular, the transmission assembly, the electric motor drive, and the electronic assembly;

FIGS. 15A-15B show the assembled housing in different side views;

FIG. 16A shows the transmission assembly to which the rotor assembly is fixed, for one variant of the assembly method;

FIG. 16B shows the transmission assembly comprising the rotor assembly with the bearing shield fixed thereto before insertion into the first housing part already carrying the stator;

FIG. 17A shows the transmission assembly with the rotor assembly fixed thereto before insertion into the first housing part, with the bearing shield not yet fixed to the transmission assembly, in a view corresponding to FIG. 16B;

FIG. 17B shows the transmission assembly already assembled to the first housing part in accordance with FIG. 17A, with the bearing shield still to be assembled;

FIG. 18 shows parts of a stepped gear wheel assembly of the transmission assembly, with a stepped gear wheel and a stepped pinion, wherein a carrier structure of the stepped gear wheel is formed here with spoke-like extending carrier portion in deviation from the previous figures, in perspective individual view;

FIG. 19 shows the stepped gear wheel and the stepped pinion of FIG. 18 with first and second bearings for the rotatable assembly in an exploded view;

FIG. 20 shows the transmission elements of the drive unit meshing with each other in an individual view;

FIG. 21 shows another variant for a stepped wheel gear with an alternatively formed carrier structure.

### DETAILED DESCRIPTION OF THE DRAWINGS

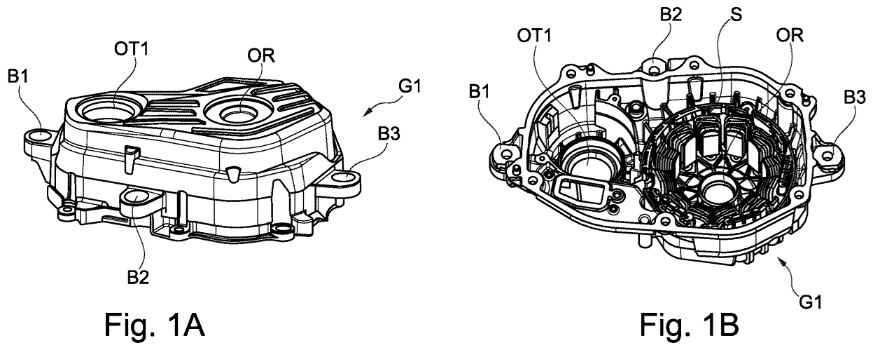

The FIGS. 1A and 1B show a first housing part G1 for an embodiment of a proposed drive unit A in different views. The first housing part G1 is formed here as a housing half which defines a housing space, in which electronic and mechanical components of the drive unit are to be accommodated, together with a second housing half. For connection to the second housing part G2, and thus in this case a second housing half, the first housing part G1 has several (at least two)—in this case three—fastening locations B1, B2, and B3 distributed on an outer circumference of the first housing part G1. In addition, a housing opening OT1 for a pedal shaft T of the drive unit A and a bearing opening R for a rotor shaft RW of an electric motor drive of the drive unit A are formed on the first housing part G1.

As can be seen in particular looking at the inside of the first housing part G1 according to the FIG. 1B, the first housing part G1 forms a motor bearing location with a bearing pot for the arrangement of a stator S of the electric motor drive. In the FIG. 1B, this stator S is already inserted into the first housing part G1 in the course of the assembly of the drive unit A.

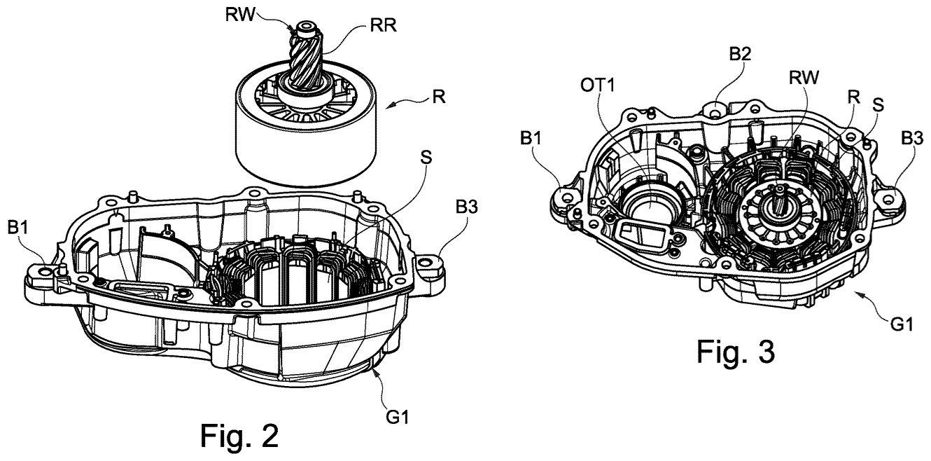

In a subsequent assembly step, a rotor assembly R is inserted into the stator S and thus into the first housing part G1, according to the FIG. 2. The rotor assembly comprises a rotor unit with sheet-clad magnets and a rotor shaft RW. A motor pinion RR is formed on the rotor shaft RW or fixed to it in a rotationally fixed manner so that a drive torque generated by the electric motor drive R, S can be transmitted via the pinion RR.

After inserting the rotor assembly R into the first housing part G1, the rotor shaft RW with the pinion R protrudes axially as shown in the FIG. 3, so that a stepped gear wheel 31 of a transmission assembly 1 can be engaged with the pinion RR.

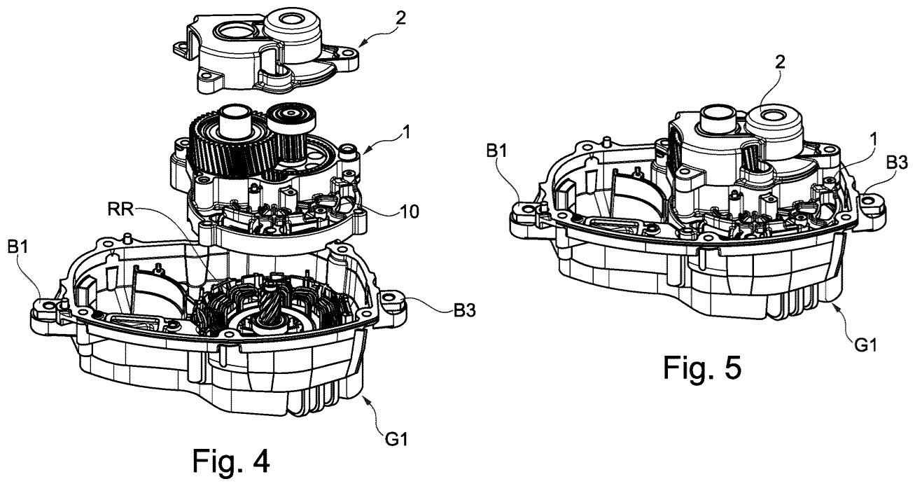

In the embodiment shown, it is provided that a transmission assembly 1 with a two-stage transmission is to be pre-assembled on a transmission carrier 10 and this pre-assembled transmission assembly 1 is to be assembled to the first housing part G1 and fixed thereto. A bearing shield 2 is then attached to the transmission carrier 10 of the transmission assembly 1. This basic procedure is illustrated based on the exploded view of the FIG. 4. The FIG. 5 shows the housing part G1 after completion of the corresponding assembly steps with the gear assembly 1 fixed thereto and the bearing shield 2 fixed to the transmission carrier 10 of the transmission assembly 1.

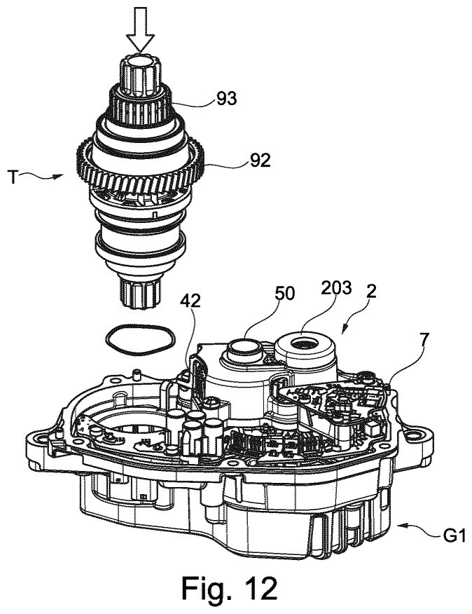

Part of the transmission assembly 1 is an intermediate gear wheel 42, via which, in the assembled state of the drive unit, an electric motor generated drive torque is transmittable to an output gear wheel 92. To this output gear wheel 92, for example, a force transmission element 93, which transmits a torque, e.g., by means of a belt wheel or chainring connected in a rotationally fixed manner to the force transmission element and via a transmission member, such as a belt or chain, to a rear wheel of an electric bicycle, is then connected in a rotationally fixed manner (see also FIGS. 12, 14, 15A-15B, and 20).

The intermediate gear wheel 42 is here annular and formed as part of an intermediate gear wheel assembly 4. The intermediate gear wheel 42 is connected in a rotationally fixed manner to a hub 41, which enables connection to a bearing 40 for the rotatable support of the intermediate gear wheel 42. Using a separate hub 41 can reduce the weight of the intermediate gear wheel 42. For example, the intermediate gear wheel 42 is made of high-strength steel, while the annular hub 41 consists of lightweight aluminum. Once the hub 41 is pressed into the annular intermediate gear wheel 42, the rotationally fixed connection to an outer ring of the bearing 40 is performed. The intermediate gear wheel assembly 4 pre-assembled in this way is then used in the course of the pre-assembly of the transmission assembly 1.

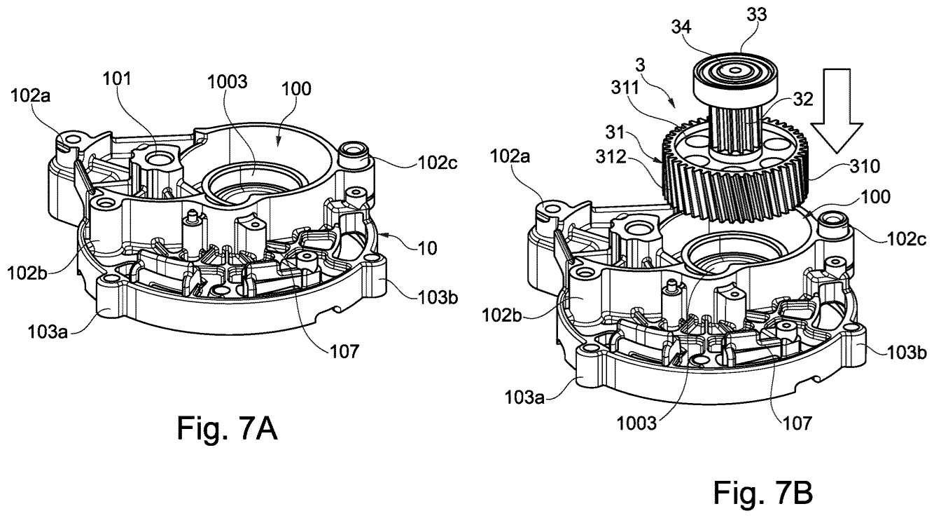

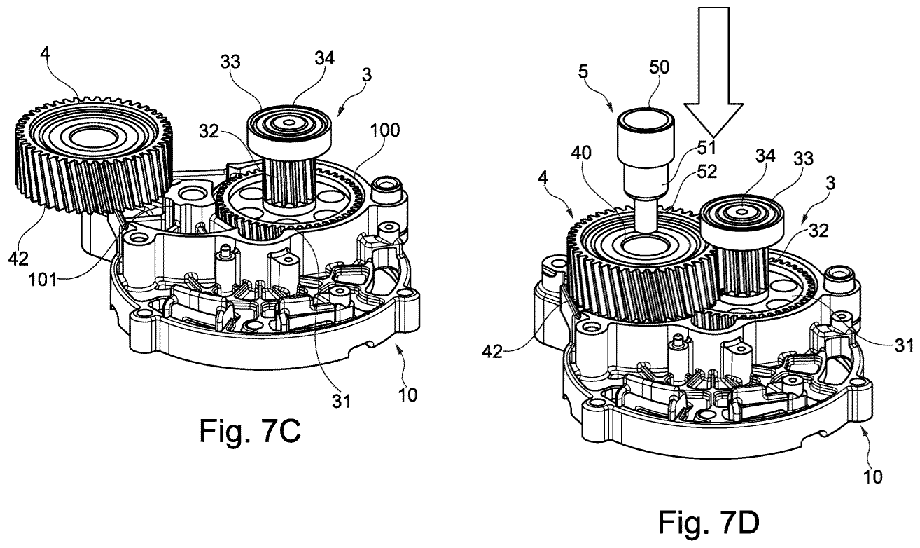

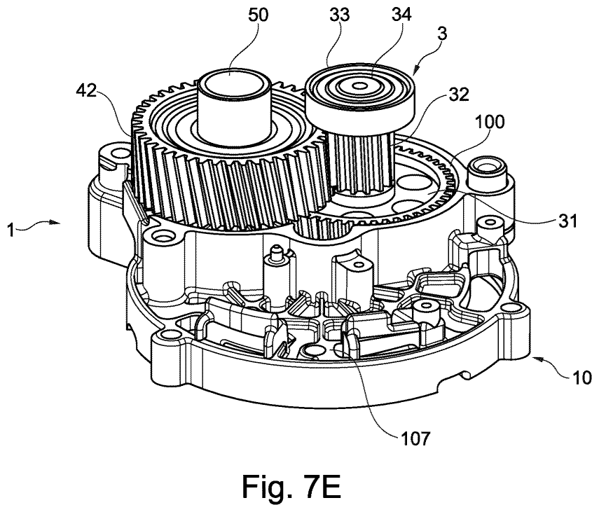

During the pre-assembly of the transmission assembly 1, the transmission carrier 10 is first provided in accordance with FIG. 7A. The transmission carrier 10 forms several fastening locations 103a to 103c, via which the transmission carrier 10 and thus later the pre-assembled transmission assembly can be fixed inside the first housing part G1, for example by means of screws or bolts. A bearing opening 100 with a bearing seat 1003 is also provided on the transmission carrier 10. The bearing opening 100 serves to accommodate the stepped gear wheel 31, which is to mesh with the pinion RR of the rotor assembly R. Offset from the bearing opening 100, a further bearing location with a bearing dome 101 is formed on the transmission carrier 10. The intermediate gear wheel assembly 4 is fixed to the bearing dome 101.

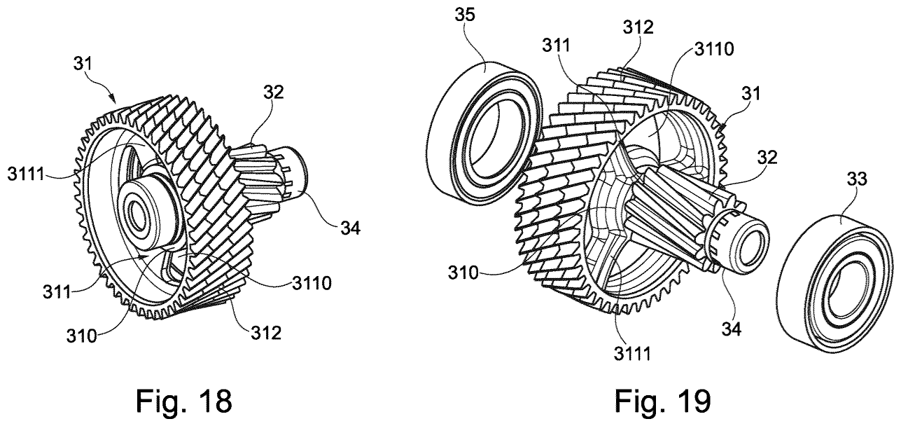

Before the arrangement of the intermediate gear wheel assembly 4, a stepped gear wheel assembly 3 is first attached to the bearing opening 100 in a first assembly step of the pre-assembly of the transmission assembly 1. In addition to the intermediate gear wheel 31, this stepped gear wheel assembly 3 has a stepped pinion 32 connected to it in a rotationally fixed manner. For the rotatable support of the stepped gear wheel 31 and the stepped pinion 32 on the transmission carrier 10, a first bearing 35, here in the form of a roller bearing (see FIGS. 18 and 19), is provided, which is fixed with its outer ring in the bearing seat 1003. A bearing shaft 34, which couples the stepped gear wheel 31 and the stepped pinion 32 to each other in a rotationally fixed manner, is rotatably supported via an inner ring of this first bearing 35. A further, second bearing 33, also in the form of a roller bearing, for example, is provided at a shaft end spaced apart from the bearing opening 100, so that the bearing shaft 34 and thus the stepped gear wheel 31 and the stepped pinion 32 are rotatably supported on the transmission carrier 10 in a defined manner about a first rotation or transmission axis of the transmission assembly 1 defined by the bearing shaft 34.

After inserting the stepped gear wheel assembly 3 onto the transmission carrier 10, as illustrated in the FIG. 7B, the arrangement of the intermediate gear wheel assembly 4 is performed in a subsequent assembly step during the pre-assembly of the transmission assembly 1. Thereby, the intermediate gear wheel assembly 4 is guided laterally onto the stepped pinion 32 so that the intermediate gear wheel 42 is brought into meshing engagement with the stepped pinion 32. Thereby, a bearing opening of the bearing 40 of the intermediate gear wheel assembly 4 is aligned with respect to the bearing opening provided on the bearing dome 101 and centered thereto.

After the lateral insertion of the intermediate gear wheel assembly 4, a radial and axial fixation of the intermediate gear wheel 42 to the transmission carrier 10 is performed via a bearing element in the form of a stepped bolt 5. The stepped bolt 5 has three consecutive portions 50, 51, and 52, which have different diameters. A first end portion 52 has the smallest diameter and is provided for pressing into the opening of the bearing dome 101. Along a longitudinal axis of the stepped bolt 5, which is hollow in this case, a central portion 51 is continuous, to which the inner ring of the bearing 41 of the intermediate gear wheel assembly 4 is fixed. A second end portion 50, which has the largest diameter, is continuous to the central portion 51 at the other axial end of the stepped bolt 5.

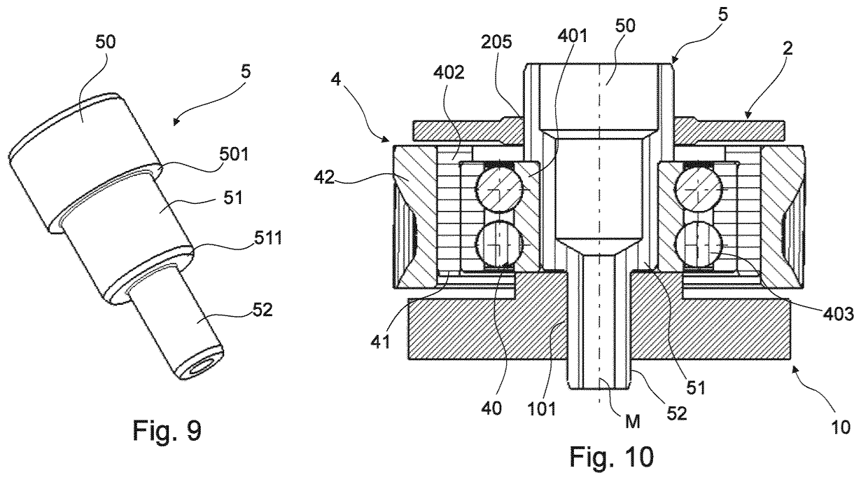

As can be seen in particular in the individual view of FIG. 9 and the sectional view of FIG. 10, the central portion 51 and the second end portion 50 each form a shoulder 511 or 501 with a (wave) shoulder. When the stepped bolt 5 is pressed in, the shoulder 511 of the central portion 51 is opposite the bearing dome 101, but without abutting against it by surface contact. Thus, the length of the central portion 51 measured along a central axis of the stepped bolt 5 is less than the width of the inner ring 401 of the bearing 40. This allows the shoulder 501 of the second end portion 50 to abut axially against the inner ring 401 when the stepped bolt 5 is pressed in and to fix the inner ring 401 axially against the bearing dome 101. By inserting the stepped bolt 5 into the intermediate gear wheel 42 or the intermediate gear wheel assembly 4 already positioned on the transmission carrier 10 and the first end portion 52 being pressed into the bearing opening of the bearing dome 101, the intermediate gear wheel assembly 4 is positioned axially and radially. The bearing 40 with its inner ring 401 serves as an end stop for the stepped bolt 5, whose central axis then defines the rotation axis for the intermediate gear 42 and thus the second transmission axis of the transmission assembly.

In the assembled state of the transmission assembly 1 shown in the FIG. 7E or the FIG. 10, the intermediate gear wheel 42 (with the hub 41) is thus fixed to the outer ring 402 of the bearing 40, while the inner ring 401 is fixed to the central portion 51 of the stepped bolt 5. In this way, the intermediate gear wheel 42 can rotate about the central axis of the stepped bolt 5 due to the roller bodies 403 of the bearing 40 provided between the inner ring 401 and the outer ring 402. The intermediate gear wheel 42 is thus rotatably supported on the transmission carrier 10 via the stepped bolt 5 so that, as part of a second transmission stage of the transmission assembly 1, it can transmit torque from the stepped pinion 32 to the output gear wheel 92.

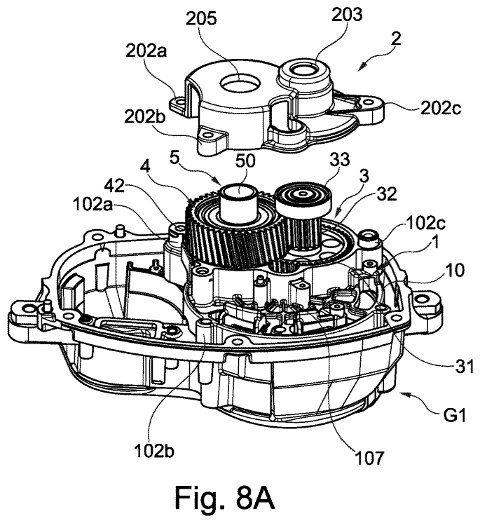

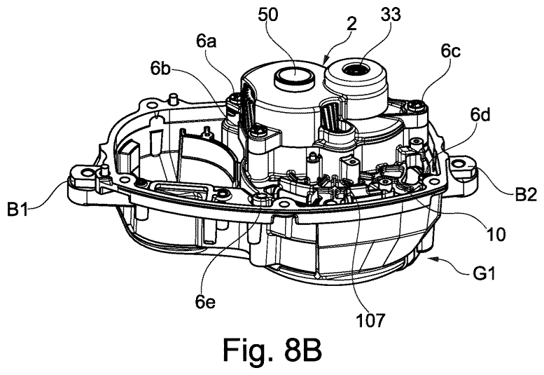

Once the transmission assembly 1 is completely pre-assembled, it is assembled to the first housing part G1 in accordance with the subsequent assembly step shown in the FIG. 8A and fixed inside the first housing part G1 using fastening elements—in this case screws 6d and 6e. The bearing shield 2 is then arranged and fixed to the transmission assembly 1 inserted into the first housing part G1 in this manner. The bearing shield 2 is aligned with fastening locations 102a, 102b, and 102c of the transmission carrier 10 at fastening openings 202a, 202b, and 202c and fixed thereto—for example, using screws 6a, 6b, and 6c.

The bearing shield 2 has a bearing location 203 for supporting the second bearing 33 of the step gear wheel assembly 3. In addition, a plug-in opening 205 for the second end portion 50 protruding axially from the intermediate gear wheel 42 is formed on the bearing shield 2. If the bearing shield 2 is assembled to the transmission carrier 10 as intended, the second bearing 33 is consequently accommodated and supported at the bearing location 203, and the protruding part of the second end portion 50 of the stepped bolt 5 passes through the plug-in opening 205 on the bearing shield 2 and is accommodated therein in a form-fitting manner. By the bearing shield 2 the stepped bolt 5 can be supported radially completely along the circumference at its second end portion 50. In addition, a part of the second end portion 50 of the stepped bolt 5 further protrudes axially from the bearing shield 2, so that additional radial support of the second end portion 50 can be provided on the second housing part G2 to be connected to the first housing part G1.

The second housing part G2 is only assembled after, among other things, an electronic assembly 7 has been assembled into the first housing part G1 in one of the subsequent assembly steps (after completion of the fixing of the bearing shield 2 to the transmission carrier 10 according to the FIG. 8B). In the present case, such an electronic assembly 7 comprises at least two circuit boards 71 and 72 connected to each other. One circuit board 72 is at least partially fixed to a bearing portion 107 of the transmission carrier 10. A portion of the transmission carrier 10 assembled to the first housing part G1 thus also serves to support and fix a part of the electronic assembly 7—in this case, a part of the circuit board 72. In the present case, the electronic assembly 7 is provided for the electronic control of the electric motor drive R, S of the drive unit A.

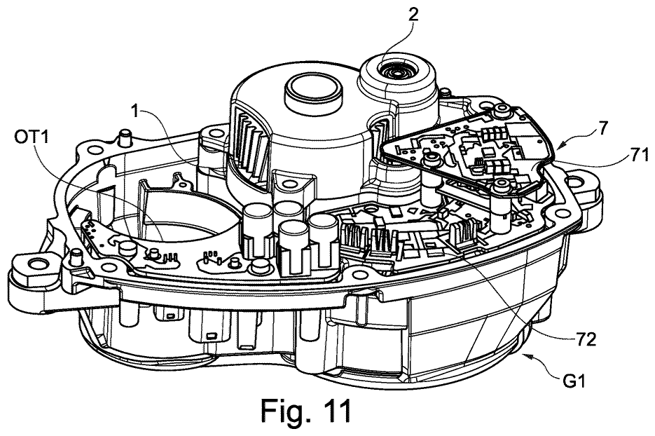

After the assembly of the electronic assembly 7 into the first housing part G1 as illustrated in the FIG. 11, in one of the subsequent further assembly steps according to the FIG. 12, insertion of the pre-assembled pedal shaft assembly T with the drive gear wheel 92 and the pedal shaft into the first housing part G1 is performed.

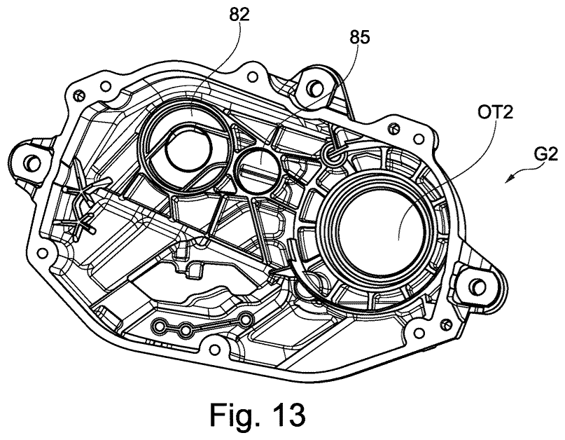

During the further course of assembly of the drive unit A, the second housing part G2 is assembled—if necessary, after completion of further assembly steps, such as the attachment of a seal to an outer circumferential edge of the first housing part G1. This second housing part G2 is shown in the FIG. 13 with a look at an inside. In addition to the housing opening OT2 for the pedal shaft of the pedal shaft assembly T already mentioned, the second housing part G1 has a recess 82 on its inner side for an axially protruding portion of the bearing shield 2, in which the second bearing 33 of the stepped gear wheel assembly 3 of the transmission assembly 1 is accommodated. A receptacle 85 for the second end portion 50 of the stepped bolt 5 is also provided on the inner side of the second housing part G2. When the housing G is closed, the part of the second end portion 50 of the stepped bolt 5 protruding from the bearing shield 2 extends into this receptacle 85, so that the second end portion 50 is also radially supported on the circumferential side in the second housing part G2 (without abutting axially against the interior of the second housing part G2).

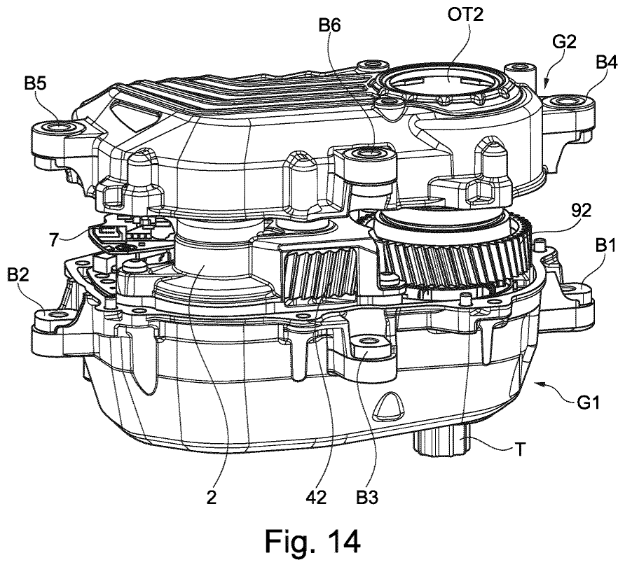

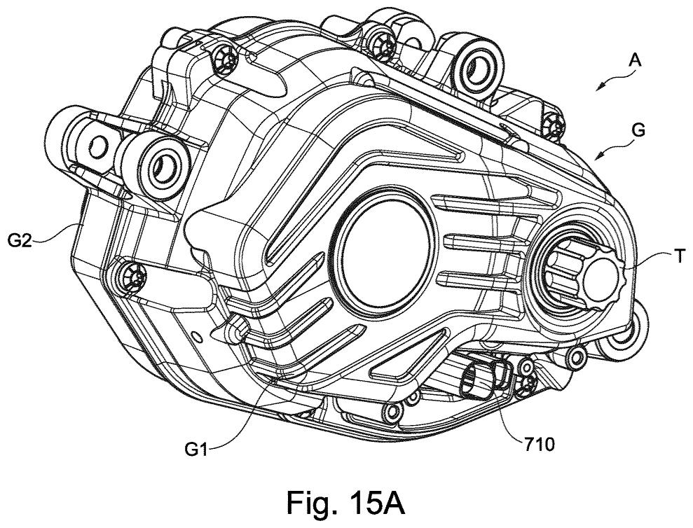

The placement of the second housing part G2 onto the first housing part G1 is shown in the FIG. 14. In this case, connecting locations B4, B5, and B6 of the second housing part G2 are aligned with connecting locations B1, B2, and B3 of the first housing part G1 so that the two housing parts G1 and G2 can be fixed to each other via the pairs of connecting locations B1/B4, B2/B5, and B3/B6. Thereby, the housing space of the housing G, which accommodates the transmission assembly 1 and the motor drive R, S, is closed in a sealing manner.

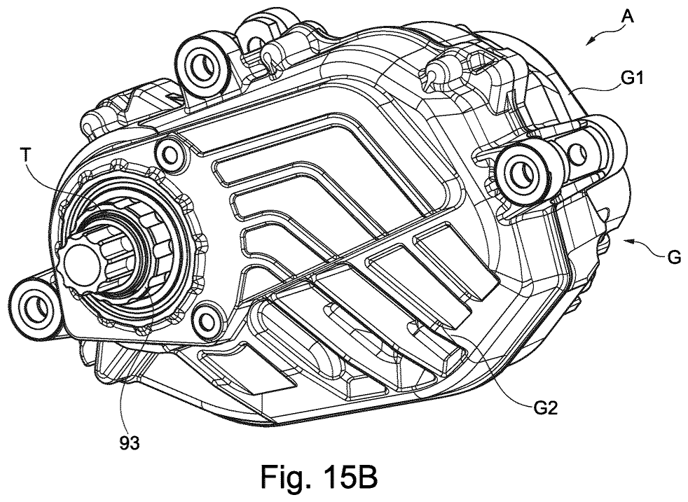

The assembled housing G of the drive unit A is shown in the FIGS. 15A and 15B from two different sides. On the side formed by the first housing part G1, a plug connector portion 710 defined by the electronic assembly 7 and leading out of the interior of the housing G is visible. This plug connector portion 710 has one or more plug connectors for connecting the drive unit A to a current supply and/or a higher-level control electronics.

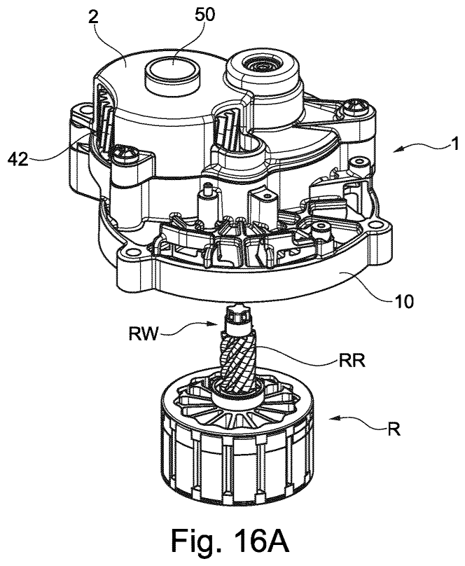

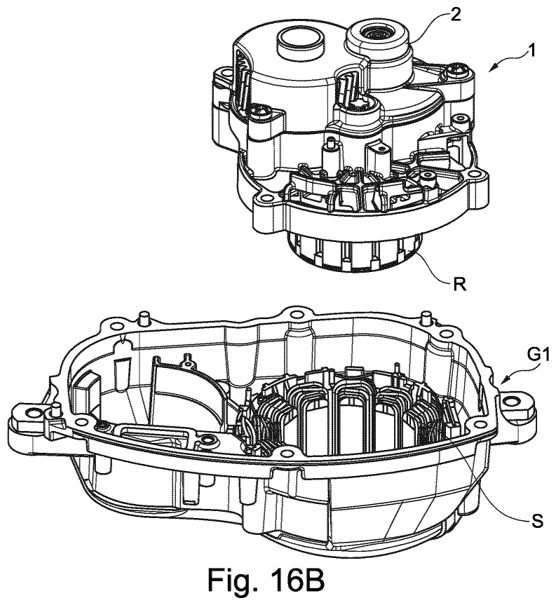

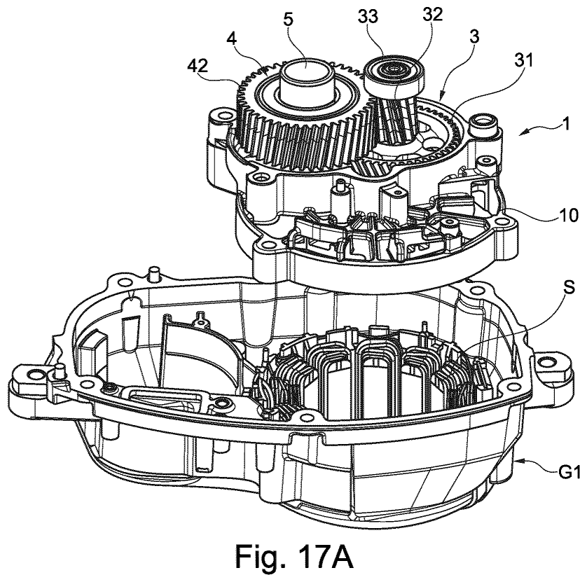

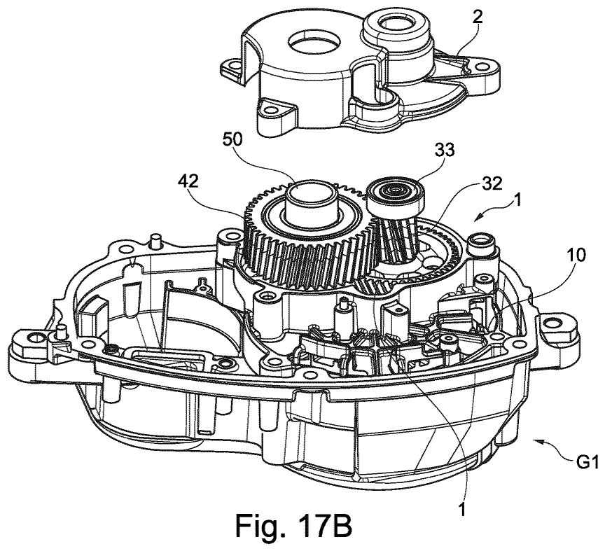

The FIGS. 16A-16B and 17A-17B illustrate two possible alternatives in assembling the transmission assembly 1 and the electric motor drive R, S.

Based on the FIGS. 16A and 16B a variant is illustrated, in which the transmission assembly 1 is completely pre-assembled and not only the bearing shield 2 is already assembled to the transmission carrier 10 before the transmission assembly 1 is assembled to the first housing part G1. Rather, the rotor assembly R is also already arranged on the pre-assembled transmission assembly or, in particular, on the transmission carrier 10, so that the pinion RR of the rotor shaft RW is brought into meshing engagement with the intermediate gear wheel 31 of the transmission assembly 1 before the transmission assembly 1 is installed in the first housing part 1. The transmission assembly 1 with the rotor assembly R already arranged thereon (which protrudes with its rotor unit on a lower side of the transmission carrier 10) is then assembled to the first housing part G1, in which only the stator S is already arranged at the motor bearing location.

In the embodiment shown in the FIGS. 17A and 17B, the rotor assembly R is also pre-assembled with the transmission assembly 1 and then inserted into the first housing part G1. In contrast to the embodiment shown in the FIGS. 16A and 16B, however, the attachment of the bearing shield 2 to the transmission carrier 10 is performed following the insertion of the transmission assembly 1 with the rotor assembly R into the first housing part G1.

The FIGS. 18 and 19 show details of an alternative configuration of the stepped gear wheel assembly 3 on an enlarged scale. In the variant of the FIGS. 18 and 19, the transmission carrier 10 is designed with a protruding flange 11, which is arranged at the bearing location of the gear carrier 10 and extends beyond the gear carrier 10.

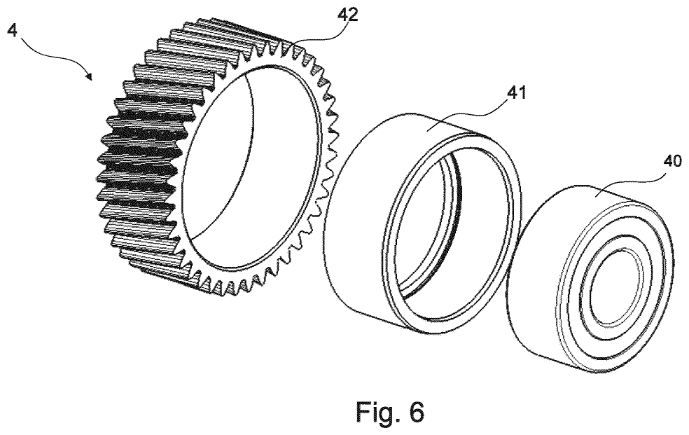

FIGS. 18 and 19 show details of an alternative design of the stepped gear assembly 3 on an enlarged scale. In the variant of the FIGS. 18 and 19, the stepped gear wheel 31 is designed differently from the design in the FIGS. 4 to 7E. The stepped gear wheel 31 of the FIGS. 18 and 19 is formed with an externally toothed ring gear 312. This ring gear 312 is connected to a hub 310 of the stepped gear wheel 31 via a carrier structure 311. The carrier structure 311 is formed by several spoke-like radially extending carrier portions 3111, so that the stepped gear wheel 31 is comparatively lightweight. In addition, comparatively large through openings 3110 are formed between the spoke-like carrier portions 3111. These have a beneficial effect on reducing airborne sound when the stepped gear wheel 31 is rotating.

The stepped gear wheel 31 is fixed in a rotationally fixed manner to a first axial end of the bearing shaft 34 forming the stepped pinion 32 via the hub 310 of the stepped gear wheel 31. The first bearing 35 is arranged on an outer circumference of the hub 310, the first bearing 35 to be inserted into the bearing seat 1003 of the bearing opening 100 in the transmission carrier 10. The second bearing 33 is fixed to the opposite axial end of the bearing shaft 34, which is radially supported in the bearing shield 2.

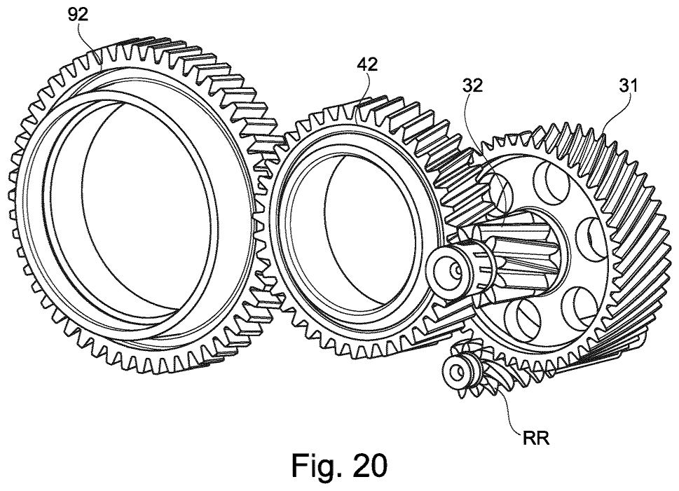

The FIG. 20 shows the interacting gear wheels of the drive unit A in an individual view. In particular, in the FIG. 20 it is shown how the pinion RR of the rotor shaft RW meshes with the stepped gear wheel 31. Via this first transmission stage of the transmission assembly 1, the torque is transmitted from the stepped pinion 32 to the intermediate gear wheel 42. The intermediate gear wheel 42 meshes not only with the stepped pinion 32, but also with the output gear wheel 92 of the pedal shaft assembly T in order to transmit the drive torque generated by the motor to a rear wheel of the electric bicycle.

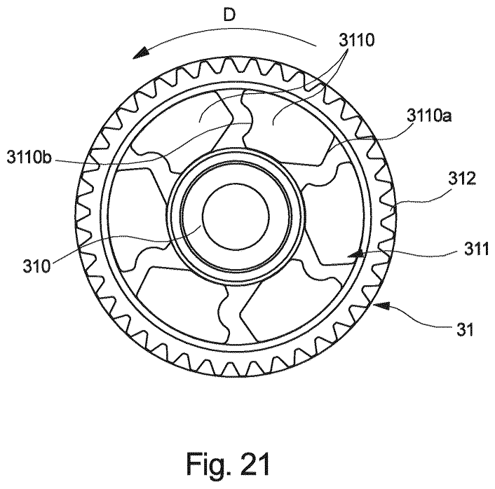

The stepped gear wheel 31 shown in the FIG. 20 corresponds in design to the stepped gear wheel 31 of the FIGS. 4 to 7E. In the FIG. 21, the stepped gear wheel is shown on an enlarged scale and in an individual view with a different design of its carrier structure 311. In the variant shown in FIG. 21, instead of circular through openings 3110 arranged in sequence along a circular line, a different contour is chosen for the through openings 3110, which also influences the contour of the carrier portions 3111 extending radially from the hub 310 to the ring gear 312. Thus, in the variant of FIG. 21, the through openings 3110 each have a contour in which the opening edges 3110a and 3110b, which are opposite each other in the circumferential direction and extend from the hub 310 towards the ring gear 312, extend in a direction opposite to the rotation direction D of the stepped gear wheel 31. In the configuration shown, these opposite opening edges 3110a and 3110b of the contour of the through openings 3110 are each centrally arrowed or curved in the direction opposite to the rotation direction D. A corresponding design of the through openings 31 10 and the resulting design of the radially spoke-like extending support portions 3111 can not only contribute to a reduction in weight on the stepped gear wheel 31. Rather, this also allows further optimization of the resulting airborne sound level during operation of the drive unit A.

### LIST OF REFERENCE SIGNS

1 Transmission assembly
10 Transmission carrier
100 Bearing opening
1003 Bearing seat
101 Bearing dome
102a-102c Fastening location
103a-103c Fastening location
107 Bearing portion
2 Bearing shield
202a-202c Fastening opening
203 Bearing location
205 Plug-in opening
3 Stepped gear wheel assembly
31 Stepped gear wheel
310 Hub
311 Carrier structure
3110 Through opening
3110a, 3110b Opening edge
3111 Carrier portion
312 Ring gear
32 Stepped pinion
33 (Roller) bearing
34 Bearing shaft
35 (Roller) bearing
4 Intermediate gear wheel assembly
40 (Roller) bearing
401 Inner ring
402 Outer ring
403 Roller body
41 Hub
42 Intermediate gear wheel
5 Stepped bolt (bearing element)
50 Second end portion
501 Shoulder
51 Central portion
511 Shoulder
52 First end portion
6a-6e Screw (fastening element)
7 Electronics assembly
71, 72 Circuit board
710 Plug connector section
82 Recess
85 Receptacle
92 Output gear
93 Force transmission element
A Drive unit
B1-B6 Connecting location
D Rotation direction
G Housing
G1, G2 Housing half (housing part)
M Central axis/rotation axis
OR Bearing opening for rotor shaft
OT1, OT2 Housing opening for pedal shaft
R Rotor assembly
RR (Motor) pinion
RW Rotor shaft
S Stator
T Pedal shaft assembly

1. A drive unit for an electric bicycle, comprising:
an electric motor drive,
a pedal shaft assembly and
a transmission assembly for transmitting a drive torque generated by the electric motor drive to an output element of the pedal shaft assembly,
wherein the transmission assembly comprises a transmission carrier, on which at least two interacting transmission elements are each rotatably supported,
one of the transmission elements is rotatably supported on the transmission carrier about a rotational axis via a bearing element, which is plugged with a first end portion into a portion of the transmission carrier in a rotationally fixed manner, specifies an axial position of the one transmission element on the transmission carrier relative to the rotation axis with a second end portion, and has a central portion provided between the first and second end portions for the rotatable support of the one transmission element.

2. The drive unit according to claim 1,
wherein the first end portion of the bearing element is pressed into an opening in the portion on the transmission carrier side.

3. The drive unit according to claim 1. wherein a shoulder is formed at the second end portion, via which the axial position of the rotatably supported transmission element is specified.

4. The drive unit according to claim 1, wherein the one transmission element is rotatably supported on the central portion of the bearing element via a bearing, the inner ring of which is connected to the central portion in a rotatably fixed manner.

5. The drive unit according to claim 3, wherein the shoulder of the second end portion abuts axially against the inner ring of the bearing.

6. The drive unit according to claim 5, wherein an axial length of the central portion is less than an axial length of the inner ring.

7. The drive unit according to claim 4, wherein the one transmission element rotatably supported via the bearing element is formed by an annular gear wheel, wherein the annular gear wheel is connected in a rotationally fixed manner to a hub, and the hub is fixed to an outer ring of the bearing, which is rotatable relative to the inner ring.

8. The drive unit according to claim 7, wherein the annular gear wheel consists of high-strength steel and the hub consists of aluminum.

9. The drive unit according to claim 1, wherein the first end portion, the central portion, and the second end portion are formed on the bearing element with different diameters, wherein a diameter of the second end portion is larger than a diameter of the central portion, and the diameter of the central portion is larger than a diameter of the first end portion.

10. The drive unit according to claim 1, wherein a bearing shield is fixed to the transmission assembly, at which the second end portion is received in a form-fitting manner.

11. : The drive unit according to claim 10, in the second end portion is received in a bearing opening of the bearing shield in a form-fitting manner and protrudes through the bearing opening.

12. The drive unit according to claim 11, wherein in the part of the second end portion protruding through the bearing opening is received in a receptacle provided in a part of a housing of the drive unit, which receives the electric motor drive and the transmission assembly provided with the bearing shield.

13. The drive unit according to claim 12, wherein the part of the second end portion protruding through the bearing opening is radially supported in the receptacle relative to the rotation axis defined by the bearing element.

14. The drive unit according to claim 1, wherein a stepped gear wheel is rotatably supported on the transmission carrier, which meshes with a pinion of a rotor shaft of a rotor assembly of the electric motor drive and is coupled to a stepped pinion as the first transmission element of the transmission assembly in a rotationally fixed manner, wherein the stepped pinion meshes with an intermediate gear wheel as the second transmission element of the transmission assembly, which is rotatably supported on the transmission carrier via the bearing element.

15. The drive unit according to claim 14, wherein the intermediate gear wheel meshes with an output gear wheel of the pedal shaft assembly.

16. The drive unit according to claim 14, wherein the stepped gear wheel and the stepped pinion are connected in a rotationally fixed manner to a bearing shaft, which is rotatably supported via a bearing received on the transmission carrier.

17. The drive unit according to claim 14, wherein the stepped gear wheel has an externally toothed ring gear and a hub, wherein the ring gear is connected to the hub of the stepped gear wheel via a carrier structure having a plurality of through openings.

18. The drive unit according to claim 17, wherein the carrier structure is formed by several carrier portions extending from the hub to the ring gear in a spoke-like manner.

19. The drive unit according to claim 17, wherein the several through openings are arranged sequentially in the carrier structure in a row extending along a circumferential direction around the rotation axis of the stepped gear wheel.

20.-23. (canceled)

24. A method for assembling a drive unit for an electric bicycle, comprising:
an electric motor drive,
a pedal shaft assembly and
a transmission assembly for transmitting a drive torque generated by the electric motor drive to an output element of the pedal shaft assembly,
wherein the transmission assembly comprises a transmission carrier, on which at least two interacting transmission elements are each rotatably supported, and the electric motor drive and the transmission assembly are accommodated in a housing of the drive unit, on which the pedal shaft assembly is rotatably supported,
the transmission assembly is pre-assembled with the at least two transmission elements already rotatably supported on the transmission carrier and interacting with each other as a structural unit and this pre-assembled structural unit is assembled to a housing part of the housing that already comprises at least a stator of the electric motor drive.

25.-34. (canceled)
